(19) United States
(12) Patent Application Publication
(10) Pub. No.: US 2025/0222851 A1
(43) Pub. Date: Jul. 10, 2025

(54) LOADABLE DROP SPREADER ASSEMBLY AND METHOD OF USE

(71) Applicant: Venture Products, Inc., Orrville, OH (US)

(72) Inventors: Derek Gerald GOODMAN, Orrville, OH (US); Aaron Edward GRABER, Massillon, OH (US)

(73) Assignee: Venture Products, Inc., Orrville, OH (US)

(21) Appl. No.: 19/004,635

(22) Filed: Dec. 30, 2024

Related U.S. Application Data
(60) Provisional application No. 63/617,494, filed on Jan. 4, 2024.

(51) Int. Cl. B60P 3/22; B60P 1/56; E01H 10/00

(52) U.S. Cl. CPC B60P 3/2245; B60P 1/56; E01H 10/007

(57) ABSTRACT

An implement for attachment with a vehicle. The implement includes at least one rail system that operably engages with the vehicle and has a first end, a second end opposite to the first end, and a longitudinal direction defined therebetween. The implement also includes a drop spreader that moveably engages with the at least one rail system along the longitudinal direction between a filling position and an operating position, wherein the longitudinal direction of the at least one rail system is nonparallel with a longitudinal direction of the vehicle.

### REFERENCE TO RELATED APPLICATIONS

This application claims the benefit of U.S. Provisional Application Ser. No. 63/617,494, filed on Jan. 4, 2024; the disclosure of which is incorporated herein by reference.

### TECHNICAL FIELD

This disclosure is directed to a loadable drop spreader assembly operably engaged with a vehicle and is moveable from beneath the vehicle between a filling position and a dispensing position.

### BACKGROUND ART

In the granular material spreaders market, there are at least two types of spreaders: broadcast spreader and drop spreaders. Commonly, these spreaders are configured to spread different types of materials (such as seed, fertilizer, salt, sand, or other dry material) based on the intended purpose.

With respect to broadcast spreaders, broadcast spreaders generally include a rotating member that centrifugally disperses the granular material from the spreader. The amount and concentration of the granular material being dispersed is controlled by adjusting the flow or amount of material being delivered to the rotating member and/or adjusting the speed of the rotating member. However, broadcast spreaders have various issues when spreading material. In one instance, broadcast spreaders also have issues with maintaining a consistent spread rate and a uniform spread width or pattern due to the nature of centrifugally dispersing material. Because broadcast spreaders do not control the spread width or pattern accurately enough, uncontrolled or uneven spread of material occurs. When broadcast spreaders are used for winter services, such as to spread deicing materials that include salt, sand, calcium chloride, magnesium chloride, and the like, such uncontrolled or uneven material spread causes damage to surrounding turf and/or landscaping, as well as causing inconsistent deicing.

To resolve these issues, drop spreaders were introduced into the markets of dropping and/or dispensing material at a precise rate and along a precise path or distance. While drop spreaders are useful in various material spreading operation mentioned above, such drop spreaders must be designed in ways that are accessible on vehicle when filling material into hoppers of these drop spreaders.

In one instance, a drop spreader may be provided at a top end or top platform of the vehicle in which the drop spreader is spaced a distance away from the ground and is accessible by the operator. However, such placement of this drop spreader may be detrimental because such drop spreader requires additional space and room on the vehicle so that the drop spreader may be accessible to the operator. Additionally, such placement of the drop spreader may also result in a wider broadcast of material due to the material being dropped from a greater height thus resulting in some material bouncing on the path and into unwanted areas that may cause harm to such areas (i.e., salt or deicing material travelling into grass or similar vegetation).

In another instance, a drop spreader may be provided on a separate implement that is equipped to the vehicle in which the drop spreader is spaced a distance away from the ground and away from the vehicle. However, such placement of this drop spreader may be detrimental because such drop spreader elongates the overall footprint of the vehicle. Such elongation of the vehicle may reduce the variety of areas of the vehicle when dropping and spreading material along tight paths or surfaces. Moreover, filling the hopper of this drop spreader may increase down time and labor time due to the length at which the operator must travel each time the hopper must be refilled.

In yet another instance, a drop spreader may be provided at a bottom end or base of the vehicle in which the drop spreader is spaced at a smaller distance away from the ground as compared to examples above. However, such placement of this drop spreader may be detrimental because such drop spreader may limit the areas and/or spaces in which the operator may fill the hopper of the drop spreader. With such limiting space, the operator must be precise in loading the hopper when the drop spreader is located at this position; however, such precision may lead to greater down times of loading and/or filling of the hopper which may delay spreading operations and increase labor time. If desired, the operator may use additional tool and or devices to prevent such loss of material; however, such use of tools and/or equipment may also lead to greater down times of loading and/or filling of the hopper which may delay spreading operations and increase labor times.

### SUMMARY OF THE INVENTION

The presently disclosed implement is mounted and/or equipped to a bottom end or base of a vehicle that is moveable between a filling position and a dispensing position. Particularly, the implement disclosed herein include a drop spreader that is slideably moveable along rails systems that directly mount to vehicle, specifically fenders of the vehicle. To fill a hopper of the drop spreader, an operator pulls the drop spreader along the rail systems to slide the hopper away from the vehicle to access the hopper. The implement disclosed herein also includes a latch assembly may also be included with the implement to releasably secure the drop spreader with the rail systems between a locked position and an unlocked position. The implement disclosed herein also includes an anti-bridging assembly to prevent material from bridging or clumping inside of the hopper during use.

In one aspect, an exemplary embodiment of the present disclosure may provide an implement for attachment with a vehicle. The implement includes at least one rail system that operably engages with the vehicle, and a drop spreader that moveably engages with the at least one rail system between a filling position and an operating position.

In another aspect, an exemplary embodiment of the present disclosure may provide an implement for attachment with a vehicle. The implement includes at least one rail system that operably engages with the vehicle, and a drop spreader that moveably engages with the at least one rail system between a filling position and an operating position, wherein the drop spreader is cantilevered from the vehicle by the at least one rail system.

This exemplary embodiment or another exemplary embodiment may further include that the at least one rail system comprises: a first end; a second end opposite to the first end; and a longitudinal direction defined between the first end and the second end; wherein the drop spreader is moveable along the longitudinal direction between the filling position and the operating position; wherein the longitudinal direction of the at least one rail system is nonparallel with a longitudinal direction of the vehicle. This exemplary embodiment or another exemplary embodiment may further include that the at least one rail system further comprises: a roller rail operably engaged with the vehicle; and wherein the drop spreader comprises: a hopper configured to hold material; and at least one set of bearings rotatably engaged with the hopper and with the roller rail to move the hopper between the filling position and the operating position. This exemplary embodiment or another exemplary embodiment may further include that the hopper further comprises: a front wall; a rear wall opposite to the front wall; a pair of side walls operably engaged with the front wall and the rear wall and spaced apart from one another; and a chamber collectively defined by the front wall, the rear wall, and the pair of side walls that holds the material; wherein the set of bearings operably engages with at least one of the front wall and the rear wall external to the chamber. This exemplary embodiment or another exemplary embodiment may further include that the at least one rail system further comprises: a stop bushing operably engaged with the roller rail; wherein when the drop spreader is in the operating position, the stop bushing contacts a first bearing of the at least one set of bearings. This exemplary embodiment or another exemplary embodiment may further include that the roller rail of the at least one rail system further comprises: a first end; a second end opposite to the first end; and a notch defined in the roller rail between the stop bushing and the second end; wherein when the drop spreader is in the operating position, the roller rail captures the first bearing of the at least one set of bearings inside of the notch. This exemplary embodiment or another exemplary embodiment may further include that the roller rail of the at least one rail system further comprises: a stop plate positioned at the second end of the roller rail and being spaced apart from the stop bushing; wherein when the drop spreader is in the filling position, the stop plates engages with a second bearing of the at least one set of bearings inside of the notch. This exemplary embodiment or another exemplary embodiment may further include that the roller rail of the at least one rail system further comprises: at least one mounting bracket configured to operably engage the at least one rail system with a front fender of the vehicle or a rear render of the vehicle. This exemplary embodiment or another exemplary embodiment may further include that that roller rail of the at least one rail system further comprises: at least one side flange configured to operably engage the at least one rail system with a frame of the vehicle. This exemplary embodiment or another exemplary embodiment may further include a latch system operably engaged with the drop spreader and the at least one rail system; wherein the latch system is configured to maintain the drop spreader in the operating position relative to the at least one rail system. This exemplary embodiment or another exemplary embodiment may further include that the latch system comprises: a strike plate fixedly engaged with the at least one rail system; and a latch fixedly engaged with the drop spreader and operably engaged with the strike plate in the operating position. This exemplary embodiment or another exemplary embodiment may further include that the latch system further comprises: a latch sensor operatively in communication with a motor of the drop spreader; wherein when the drop spreader is provided in the operating position, the latch sensor is in an activated state to allow the motor to operate; and wherein when the drop spreader is provided in the filling position, the latch sensor is in a deactivated state to prevent the motor from operating. This exemplary embodiment or another exemplary embodiment may further include at least another rail system operably engaged with the vehicle and positioned opposite to the at least rail system; wherein the drop spreader is moveably engaged with the at least one rail system and the at least another rail system between the filling position and the operating position.

In another aspect, an exemplary embodiment of the present disclosure may provide an implement for attachment with a vehicle. The implement includes at least one rail system that operably engages with the vehicle and has a first end, a second end opposite to the first end, and a longitudinal direction defined therebetween. The implement also includes a drop spreader that moveably engages with the at least one rail system along the longitudinal direction between a filling position and an operating position. The longitudinal direction of the at least one rail system is nonparallel with a longitudinal direction of the vehicle.

In another aspect, an exemplary embodiment of the present disclosure may provide an implement for attachment with a vehicle. The implement includes at least one rail system that operably engages with the vehicle and has a first end, a second end opposite to the first end, and a longitudinal direction defined therebetween. The implement also includes a drop spreader that moveably engages with the at least one rail system along the longitudinal direction between a filling position and an operating position. The implement also includes a controller that electrically connects with the drop spreader, wherein the controller is configured to control a rate of dropping material from the drop spreader to a ground surface.

In another aspect, an exemplary embodiment of the present disclosure may provide a method of spreading a material along a ground surface. The method includes steps of: engaging an implement to a vehicle, the implement comprising: at least one rail system operably engaged with the vehicle; and a drop spreader moveably engaged with the at least one rail system between a filling position and an operating position; moving the drop spreader along the rail system in a first linear direction from the operating position to the filling position; filling the drop spreader with the material in the filling position; moving the drop spreader along the rail system in a second linear direction from the filling position to the operating position; and spreading the material along the ground surface.

In another aspect, an exemplary embodiment of the present disclosure may provide a method of spreading a material along a ground surface. The method includes steps of engaging an implement to a vehicle, the implement comprising: at least one rail system operably engaged with the vehicle; and a drop spreader moveably engaged with the at least one rail system between a filling position and an operating position, wherein the drop spreader is cantilevered from the vehicle by the at least one rail system; moving the drop spreader along the at least one rail system in a first linear direction from the operating position to the filling position; filling the drop spreader with the material in the filling position; moving the drop spreader along the at least one rail system in a second linear direction from the filling position to the operating position; and spreading the material along the ground surface.

This exemplary embodiment or another exemplary embodiment may further include that the steps of moving the drop spreader along the at least one rail system in the first and second linear directions further includes that the first and second linear directions are nonparallel with a longitudinal direction of the vehicle. This exemplary embodiment or another exemplary embodiment may further include that the steps of moving the drop spreader along the at least one rail system in the first and second linear directions further comprises: engaging at least one set of bearings of the drop spreader with a roller rail of the at least one rail system; and sliding the drop spreader along the roller rail. This exemplary embodiment or another exemplary embodiment may further include a step of stopping a first bearing of the at least one set of bearings with a stop bushing of the at least one rail system; and wherein engagement between the first bearing and the stop bushing defines the filling position. This exemplary embodiment or another exemplary embodiment may further include steps of capturing a first bearing of the at least one set of bearings inside of a notch defined by the roller rail; and holding the drop spreader at the filling position. This exemplary embodiment or another exemplary embodiment may further include steps of stopping a second bearing of the at least one set of bearings with a stop plate of the at least one rail system; and wherein engagement between the second bearing and the stop plate defines the operating position. This exemplary embodiment or another exemplary embodiment may further include steps of disengaging a latch of a latch assembly from a strike plate of the latch assembly; and enabling movement of the drop spreader between the filling position and the operating position relative to the at least one rail system. This exemplary embodiment or another exemplary embodiment may further include steps of activating operation of a motor of the drop spreader, by a latch sensor of the latch assembly, when the drop spreader is in the operating position; and deactivating operation of the motor of the drop spreader, by the latch sensor of the latch assembly, when the drop spreader is in the filling position.

### BRIEF DESCRIPTION OF THE DRAWINGS

Sample embodiments of the present disclosure are set forth in the following description, are shown in the drawings and are particularly and distinctly pointed out and set forth in the appended claims.

FIG. 1 is a partial side elevation view of an implement equipped to a vehicle in accordance with one aspect of the present disclosure, wherein the implement is dispensing material onto a ground surface

FIG. 1A is a partial side elevation view similar to FIG. 1, but the implement is removed from the vehicle.

FIG. 2 is a first side elevation view of the implement shown in FIG. 1.

FIG. 3A is a rear, first side, top isometric perspective view of the implement shown in FIG. 1.

FIG. 3B is a front, second side, top isometric perspective view of the implement shown in FIG. 1.

FIG. 4 is a first side elevation view of the implement shown in FIG. 1, wherein a first shroud of a drop spreader of the implement is removed.

FIG. 5 is a second side elevation view of the implement shown in FIG. 1, wherein a second shroud of the drop spreader of the implement is removed.

FIG. 6 is a sectional view of the implement taken in the direction of line 6-6 shown in FIG. 3A.

FIG. 6A is an enlargement of the region highlighted in FIG. 6.

FIG. 7 is a sectional view of the implement taken in the direction of line 7-7 shown in FIG. 6A.

FIG. 8 is a partial sectional view of a latch assembly of the implement, wherein a latch of the latch assembly is engaged with a strike plate of the latch assembly to maintain the drop spreader in the dispensing position.

FIG. 9 is a top plan view of the implement engaged with the vehicle, wherein the implement is provided in the dispensing position.

FIG. 10 is an operational view of the implement showing the drop spreader being slid along the rail systems from the dispensing position to the filling position.

FIG. 11 is another operational view similar to FIG. 10, but a predetermined amount of material is being loaded into the hopper of the drop spreader.

FIG. 12 is another operational view similar to FIGS. 10 and 11, wherein a bearing of the drop spreader is engaged with a rail of one of the rail systems inside a notch defined in said rail to maintain the drop spreader in the filling position.

Similar numbers refer to similar parts throughout the drawings.

### DETAILED DESCRIPTION

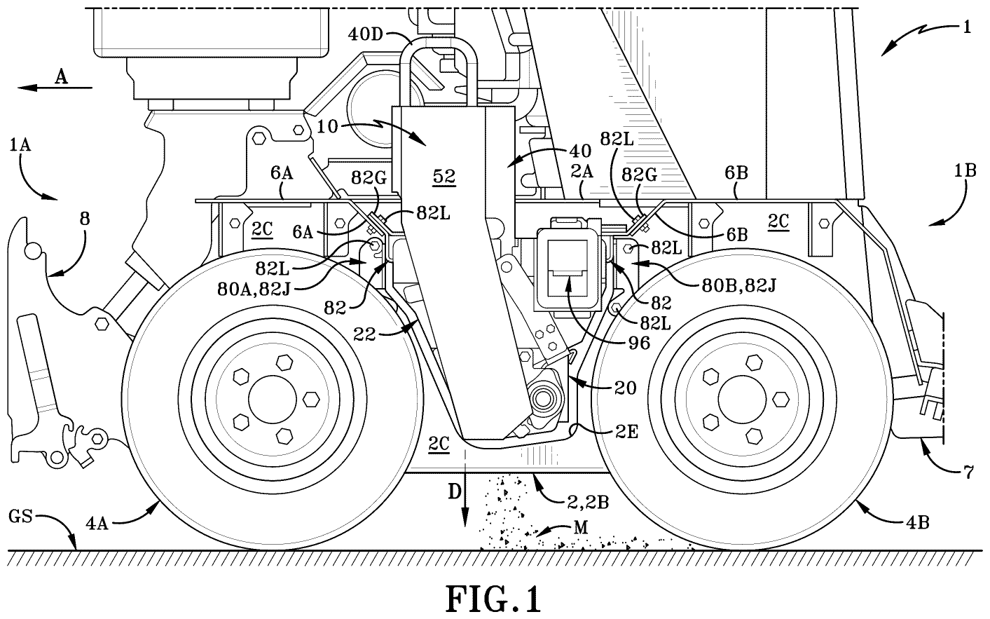

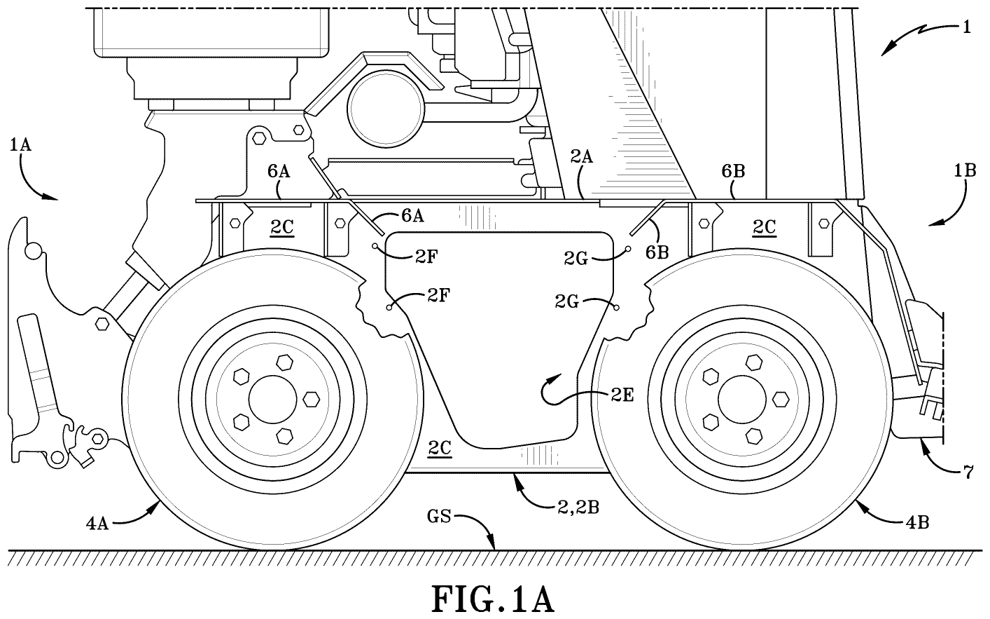

A drivable outdoor power equipment device in accordance with the present disclosure is illustrated in FIGS. 1-1A and is shown generally at 1; the drivable outdoor power equipment device 1 may also be referred to as a tractor or vehicle herein. Vehicle 1 has a front end 1A, a rear end 1B longitudinally opposite to the front end 1A, and a longitudinal direction defined therebetween. Vehicle 1 further includes a first or left side 1C, a second or right side 1D transversely opposite to the first side 1C, and a transverse direction defined therebetween.

During operation, vehicle 1 will typically travel in a forward direction indicated by the arrow “A” (FIG. 1) that is generally parallel to longitudinal direction. When vehicle 1 moves in the forward direction “A”, the front end 1A comprises the leading end of vehicle 1. In some instances, vehicle 1 may need to reverse, in which case the direction of travel will be opposite to the direction indicated by arrow “A”, and then rear end 1B will comprise the leading end of the vehicle 1.

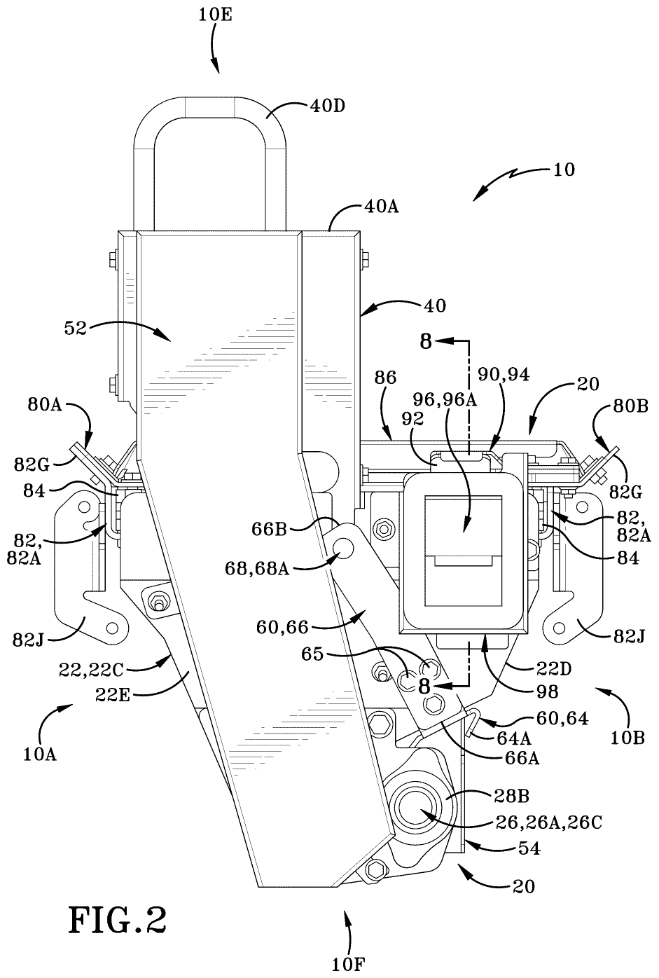

It should be understood that the terms “front”, “rear”, “top”, “bottom”, “left”, and “right” are used to described the orientation of the vehicle 1, equipment, or implements illustrated in the attached figures and should in no way be considered to limit the orientation that the vehicle 1, equipment, or implements may be utilized. In addition, the use of the directional terms “front”, “rear”, “top”, “bottom”, “left”, and “right” is taken in perspective of FIG. 2 (i.e. viewing the vehicle 1, equipment, or implements from the rear end 1B).

Vehicle 1 includes a frame 2 upon which grounding engaging wheels are mounted so that vehicle 1 may be driven across a ground surface “GS” (see FIG. 1). It will be understood that frame 2 includes many other component plates and flanges that are not illustrated in the figures. Yet other components and plates of frame 2 may be illustrated but these will then simply be identified in the various figures by the reference number “2” to indicate that they form part of the frame 2.

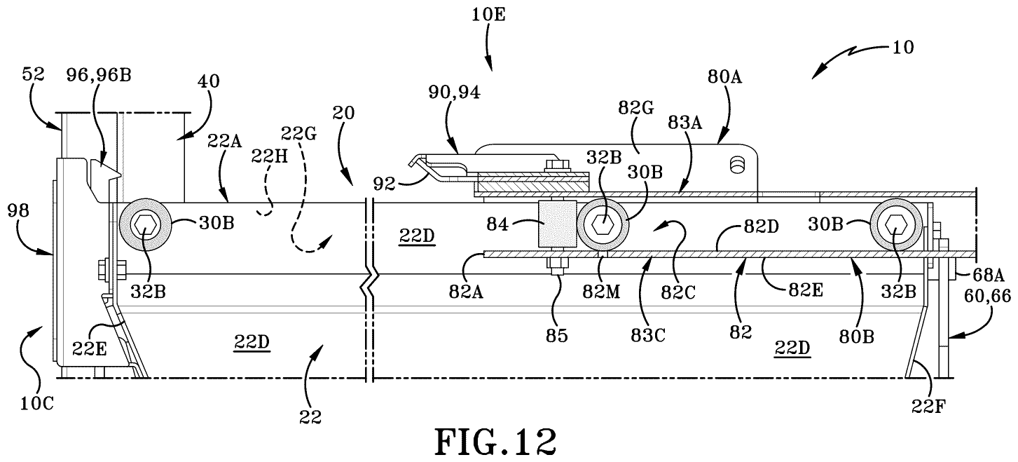

As best seen in FIG. 1, the frame 2 may include a generally rectangular-shaped box (see FIG. 12) that has an upper end 2A that is spaced vertically above a lower end 2B. Frame 2 also includes a pair of sides 2C, 2D (see FIG. 12) spaced laterally apart from one another and extends between the upper end 2A of the frame 2 and the lower end 2B of the frame 2. One or both sides 20, 2D may define a hole 2E therein. Hole 2E may originally be closed over with a metal plate. The metal plate may be selectively removed to permit access through hole 2E, as will be described later herein. Frame 2 also defines a front pair of attachment openings 2F and a rear pair of attachment openings 2G. As best seen in FIG. 1A, the front pair of attachment openings 2F is defined at the first side 2C of the frame 2, and the rear pair of attachment openings 2G is defined at the second side 2D of the frame 2. As discussed in greater detail below, the front pair of attachment openings 2F and the rear pair of attachment openings 2G serve as mounting points for accessories and equipment with the frame 2.

Vehicle 1 includes a pair of laterally spaced apart front wheels 4A and a pair of laterally spaced apart rear wheels 4B. As best seen in FIG. 12, the front wheels 4A and the rear wheels 4B are positioned outside of the sides 2C of the frame 2 when view from a top plan view. Front wheels 4A and rear wheels 4B are mounted on frame 2 in such a way that they have a fixed orientation relative to frame 2. In other words, while wheels 4A, 4B are individually rotatable about a horizontally oriented axis, wheels 4A, 4B are not able to pivot to the left or to the right relative to the frame. Vehicle 1 is steered by applying more or less drive torque to wheels 4A, 4B on the left side of vehicle 1 relative to the drive torque applied to the wheels 4A, 4B on the right side of vehicle 1. In other words, vehicle 1 is a powered vehicle that has differential steering.

Although shown and discussed as having wheels 4A, 4B and being of a skid steer style, it will be understood that vehicle 1 may, instead, be any of a number of different driven vehicles, including but not limited to, a tracked vehicle, a skid steer, a tractor, an all-terrain vehicle, a zero-turn vehicle, or any other similar type of gasoline-powered, electrically-powered or otherwise powered and driven device. For simplicity, the present description will be directed to the skid steer styled vehicle shown in the attached figures but it will be understood that the aspects of the present disclosure could be used on any other similar vehicle.

Vehicle 1 also includes a pair of front fenders 6A and a pair of rear fenders 6B are mounted to frame 2. As best seen in FIGS. 1-1A and 12, the pair of front fenders 6A and the pair of rear fenders 6B extend outwardly from a respective side of the pair of sides 2C, 2D of the frame 2 when viewed from a top plan view. The pair of front fenders 6A and the pair of rear fenders 6B are positioned in such a way as to cover a portion of the associated wheel 4A, 4B to shield various components of vehicle 1 as well as the operator of the vehicle 1. The front fenders 6A and the pair of rear fenders 6B also aid in preventing debris from being thrown up from wheels 4A, 4B during operation of vehicle 1. The front fenders 6A and the pair of rear fenders 6B may also serve as mounting points for accessories and equipment along with the front pair of attachment openings 2F and the rear pair of attachment openings 2G; such mounting points of the front fenders 6A and the pair of rear fenders 6B are discussed further herein.

Vehicle 1, as illustrated, is a stand-on machine. Typically, an operator will be positioned proximate rear end 1B of vehicle 1 and the attachments and implements will be located forward of the operator. An operator platform 7 (FIGS. 1 & 2) may be mounted on frame 2 and extends rearward therefrom proximate the rear end 1B of vehicle 1. Operator platform 7 is configured so that the operator will stand on platform 7. It will be understood that in vehicles other than the skid steer style vehicle, the operator may be seated on a seat instead of standing on a platform. In those instances, the seat for the operator may be located somewhere between front end 1A and rear end 1B of vehicle 1. While not illustrated herein, a vehicle 1 may include a control panel (not illustrated) with necessary controls so that the operator may move the vehicle 1, steer the vehicle 1, and operate equipment or implements that are equipped to the vehicle 1. The control panel may also be positioned above the operator platform 7 at a height that is ergonomic for the operator of the vehicle 1.

Vehicle 1 may further include hitch arms 8 that are pivotably engaged with the frame 2 and positioned at the front end 1A of the vehicle 1. While not illustrated herein, hitch arms 8 are configured to engage with one or more snow removal accessory or implements when operating drop spreader mentioned in greater detail below. In one exemplary embodiment, a snow plow, a snow blade, a box or push plow, or another similar type of implement may be equipped to hitch arms 8 for pushing and/or removing snow while operating a drop spreader mentioned herein. In another exemplary embodiment, a snow blower, a snow sweeper, a snow brush, and another similar type of implement may be equipped to hitch arms 8 for throwing and/or removing snow while operating a drop spreader mentioned herein.

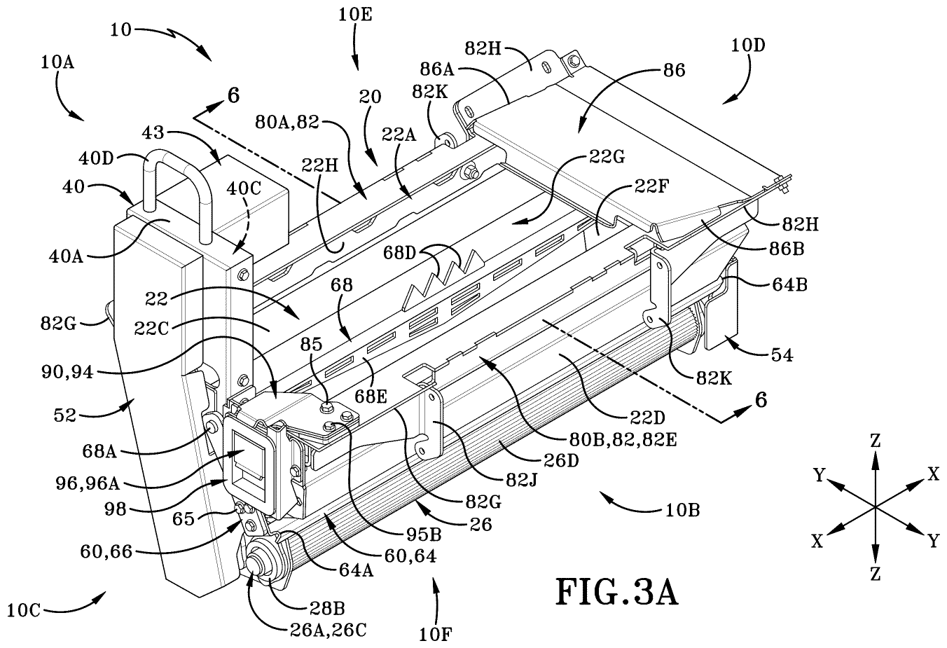

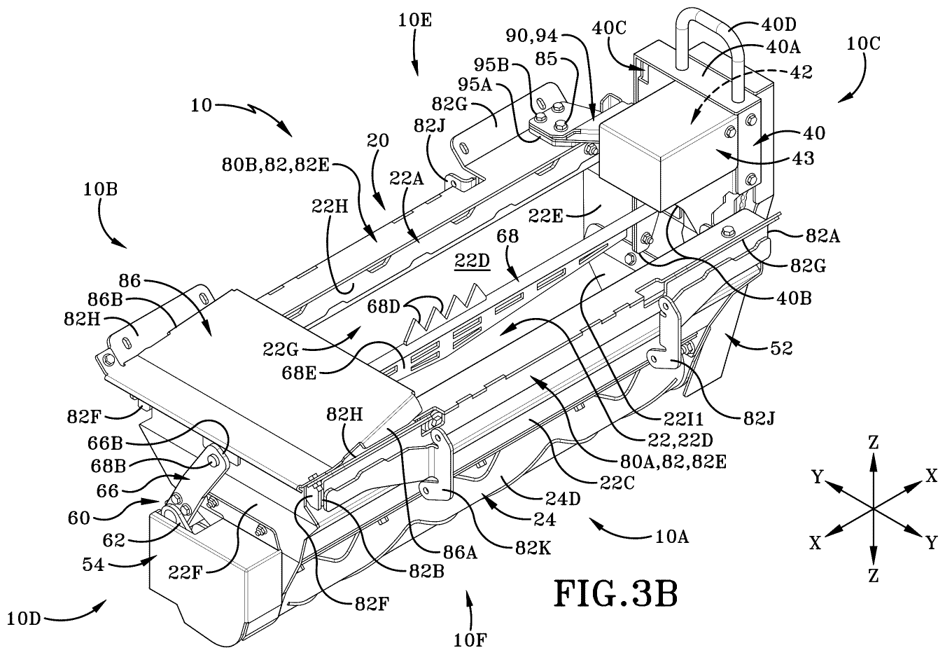

An outdoor power equipment device, which may also be referred to as an implement or drop spreader assembly, is generally shown throughout the figures as 10. As best seen in FIGS. 3A-3B, implement 10 includes a front end 10A, a rear end 10B opposite to the front end 10A, and a first direction “Y” defined therebetween. Implement 10 also includes a first side or left side 10C, a second side or right side 10D opposite to the front end 10A, and a second direction “X” defined therebetween. Implement 10 also include a top end 10E, a bottom end 1F opposite to the top end 10E, and a third direction defined “Z” therebetween.

It should be understood that implement 10 may be operably engaged with the vehicle 1 at any suitable location. In one particular embodiment, implement 10 operably engages with the front fenders 6A and the rear fenders 6B and is positioned between the front wheels 4A and the rear wheels 4B of the set of ground engaging wheels 4. In the same particular embodiment, implement 10 also operably engages with the frame 2 at the front pair of attachment openings 2F that is positioned behind the front fender 6A and at the rear pair of attachment openings 2G that is positioned ahead of the rear fender 6B. One exemplary vehicle 1 for use with implement 10 is a Ventrac compact tractor commercially available for sale and known in the industry as a Ventrac Sidewalk Snow Vehicle (SSV). The vehicle 1 may include an all-wheel drive system where the frame 2 is an articulating frame.

Implement 10 includes a drop spreader 20 that is configured to hold and spread material along a path or ground surface that is parallel with the longitudinal direction of the vehicle 1. In the present disclosure, the drop spreader 20 is configured to be moveable along the second direction “X” of the implement 10 to a filling position so that the drop spreader 20 is filled with material for desired purposes, such as deicing material or material to provide traction along a ground surface. The drop spreader 20 is also configured to be moveable from the filling position to an operating or dispensing position so that the drop spreader 20 may dispense or spread material along the ground surface. Such parts and components of the drop spreader 20 are now discussed in greater detail below.

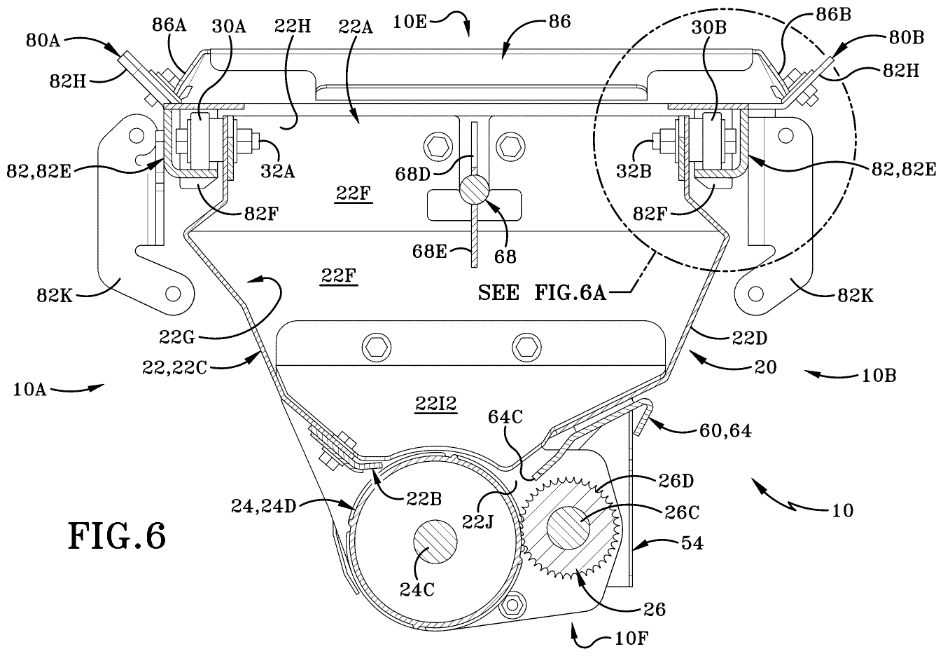

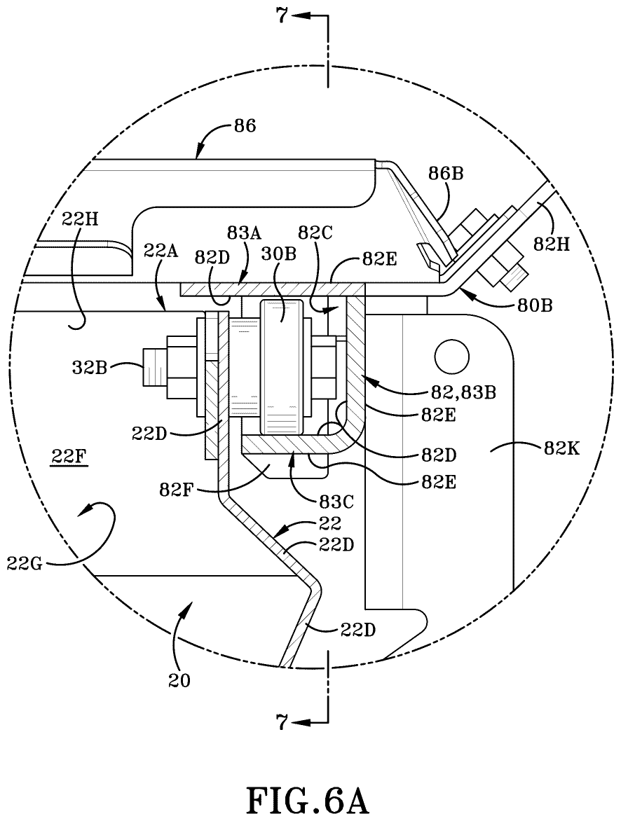

Drop spreader 20 includes a hopper 22. As best seen in FIG. 6, the hopper 22 includes a top end 22A, a bottom end 22B that is opposite to the top end 22A, and a vertical direction defined therebetween. Still referring to FIG. 6, hopper 22 also includes a front wall 22C that extends vertically between the top end 22A and the bottom end 22B, a rear wall 22D that extends vertically between the top end 22A and the bottom end 22B and is opposite to the front wall 22C, and a pair of side walls 22E, 22F that extends vertically between the top end 22A and the bottom end 22B and is spaced apart from one another. With respect to the side walls 22E, 22F, a first side wall 22E is positioned between the front wall 22C and the rear wall 22D and positioned at the first side 10C of implement 10. Still referring to the side walls 22E, 22F, a second side wall 22F is positioned between the front wall 22C and the rear wall 22D and positioned at the second side 10D of implement 10 opposite to the first side wall 22E.

Still referring to hopper 22, hopper 22 defines a chamber 22G. As best seen in FIG. 6, the chamber 22G is collectively defined by the front wall 22C, the rear wall 22D, and the pair of side walls 22E, 22F. The chamber 22G is accessible at a first or fill opening 22H that is collectively defined by the front wall 22C, the rear wall 22D, and the pair of side walls 22E, 22F at the top end 22A. The chamber 22G is accessible at a second or dispense opening 22J that is collectively defined by the front wall 22C, the rear wall 22D, and a pair of funnel walls 22I1, 22I2 at the bottom end 22B. As best seen in FIG. 3B, a first funnel wall 22I1 operably engages with the first side wall 22E inside of the chamber 22G and extends downwardly from the first side wall 22E. As best seen in FIG. 6, a second funnel wall 22I2 operably engages with the second side wall 22F inside of the chamber 22G and extends downwardly from the second side wall 22F.

In operation, a user of implement 10 fills the hopper 22 at the fill opening 22H with a desired amount of material. Upon such loading such material, the pair of funnel walls 22I1, 22I2 assist in funneling and/or moving the material downwardly inside of the hopper 22 towards the dispense opening 22J. As discussed in greater detail below, the material loaded in the hopper 22 is then dispensed and/or dropped through the dispense opening 22J onto a ground surface at a predetermined rate that is selected by the operator.

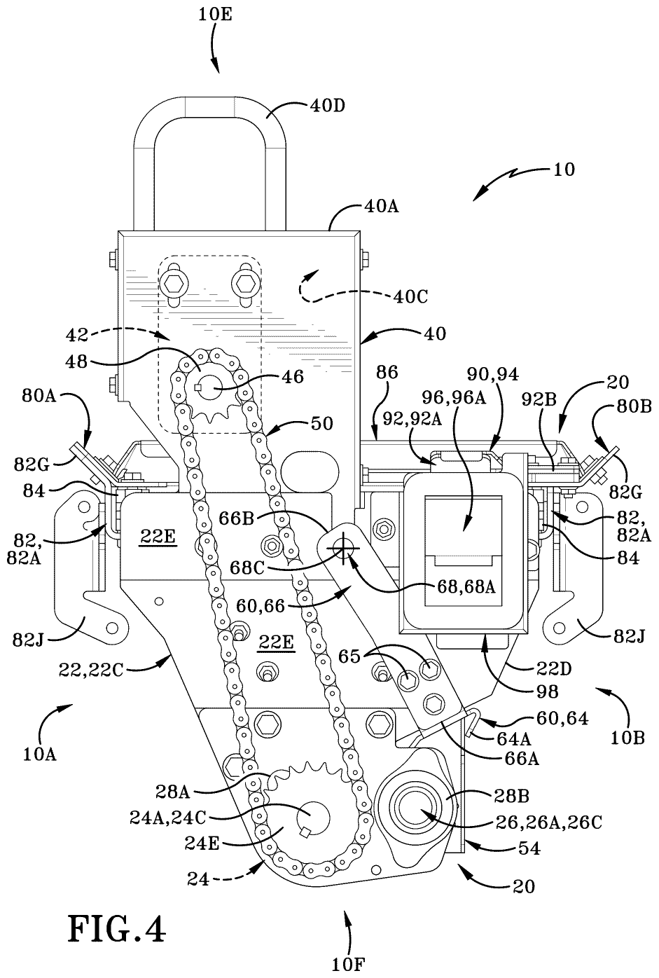

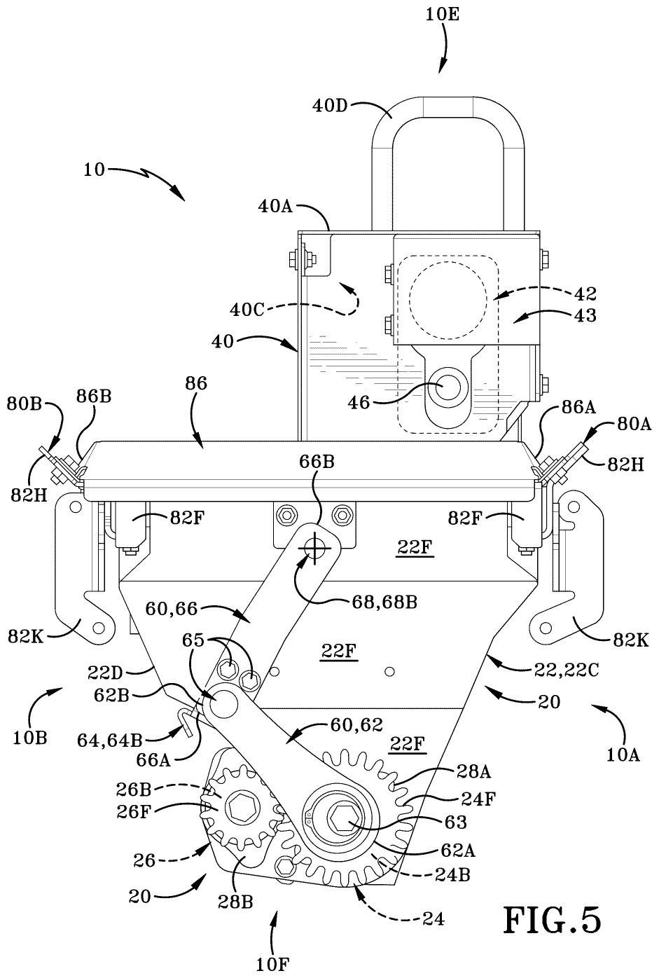

Drop spreader 20 also includes a rotor 24 that is rotatably engaged with the hopper 22. As best seen in FIGS. 3B-4, the rotor 24 includes a first end 24A, a second end 24B opposite to the first end 24A (see FIG. 5), and a longitudinal axis defined therebetween. In the present disclosure, the first end 24A operably engages with the hopper 22 at first side wall 22E, and the second end 24B operably engages with the hopper 22 at the second side wall 22F. Rotor 24 also includes a drive shaft 24C that extends between the first end 24A and the second end 24B and is surrounded by a grinder wall 24D. The grinder wall 24D is configured to engaged with the material loaded in the hopper 22 to dispense said material from the hopper 22 at a predetermined rate that is selected by the operator. In the present disclosure, the rotor 24 is positioned partially inside of the dispense opening 22J of the hopper 22 in which the rotor 24 partially covers the dispense opening 22J (see FIG. 6).

Still referring to rotor 24, rotor 24 also includes a rotor sprocket 24E and a rotor gear 24F. In the present disclosure, the rotor sprocket 24E operably engages with the drive shaft 24C at the first end 24A (see FIG. 4), and the rotor gear 24F operably engages with the drive shaft 24C at the second end 24B (see FIG. 5). In the present disclosure, the rotor sprocket 24E is located adjacent to the first side wall 22E of the hopper 22 and is external to the chamber 22G. In the present disclosure, the rotor gear 24F is also located adjacent to the second side wall 22F of the hopper 22 and is external to the chamber 22G. Such use and purpose of the rotor sprocket 24E and the rotor gear 24F are discussed in greater detail below.

Drop spreader 20 also includes a compression roller 26 that is rotatably engaged with the hopper 22 and contacts rotor 24. As best seen in FIGS. 4 and 5, the compression roller 26 includes a first end 26A, a second end 26B opposite to the first end 26A, and a longitudinal axis defined therebetween. In the present disclosure, the first end 26A operably engages with the hopper 22 at the first side wall 22E of the hopper 22, and the second end 26B operably engages with the hopper 22 the second side wall 22F of hopper 22. Compression roller 26 also includes a drive shaft 26C that extends between the first end 26A and the second end 26B and is surrounded by a compression wall 26D. The compression wall 26D is configured to engaged with the material loaded in the hopper 22 to dispense said material from the hopper 22 at a predetermined rate simultaneously with the rotor 24, which is discussed in greater detail below. In the present disclosure, the compression roller 26 is positioned outside of the dispense opening 22J of the hopper 22 in which the compression roller 26 is positioned away from dispense opening 22J (see FIG. 6). The compression roller 26 is also positioned below the dispense opening 22J in order to receive and dispense material from the hopper 22 at a predetermined rate in conjunction with the rotor 24.

Still referring to compression roller 26, compression roller 26 also includes a roller gear 26F. As best seen in FIG. 5, the roller gear 26F operably engages with the drive shaft 26C at the second end 26B. In the present disclosure, the roller gear 26F is located adjacent to the second side wall 22F of the hopper 22 and is external to the chamber 22G. Upon assembly, the rotor gear 24F of the rotor 24 and the roller gear 26F of the compression roller 26 mesh with one another to transfer rotational force from the rotor 24 to the compression roller 26; such rotation of the rotor 24 and the compression roller 26 is discussed in greater detail below.

It should be understood that any suitable granular material that is conventional and/or commercially used for deicing operation and/or traction operation in various precipitation situation may be loaded into hopper 22 and be collectively dispensed by the rotor 24 and the compression roller 26. Examples of suitable granular material that may be loaded into a hopper and collectively dispensed by a rotor and a compression roller include, but are not limited to, include salt, sand, calcium chloride, magnesium chloride, and other suitable granular material that is conventional and/or commercially used for deicing operation and/or traction operation.

Drop spreader 20 may also include a first set of pillow block bearings 28A. As best seen in FIGS. 4 and 5, the first set of pillow block bearings 28A operably engages with the rotor 24, particularly the drive shaft 24C of the rotor 24, and the pair of side walls 22E, 22F of the hopper 22. In the present disclosure, a first pillow block bearing of the first set of pillow block bearings 28A operably engages with the drive shaft 24C at the first end 24A and with the first side wall 22E of the hopper 22. Additionally, a second pillow block bearing of the first set of pillow block bearings 28A operably engages with the drive shaft 24C at the second end 24B and with the second side wall 22F of the hopper 22. Such use of the first set of pillow block bearings 28A provides axial and rotational support to the drive shaft 24C of the rotor 24 as the rotor 24 rotates about the longitudinal axis of the rotor 24.

Similarly, drop spreader 20 may also include a second set of pillow block bearings 28B. As best seen in FIGS. 4 and 5, the second set of pillow block bearings 28B operably engages with the compression roller 26, particularly the drive shaft 26C of the compression roller 26, and the pair of side walls 22E, 22F of the hopper 22. In the present disclosure, a first pillow block bearing of the second set of pillow block bearings 28B operably engages with the drive shaft 26C at the first end 26A and with the first side wall 22E of the hopper 22. Additionally, a second pillow block bearing of the second set of pillow block bearings 28B operably engages with the drive shaft 26C at the second end 26B and with the second side wall 22F of the hopper 22. Such use of the second set of pillow block bearings 28B provides axial and rotational support to the drive shaft 26C of the compression roller 26 as the compression roller 26 rotates about the longitudinal axis of the compression roller 26.

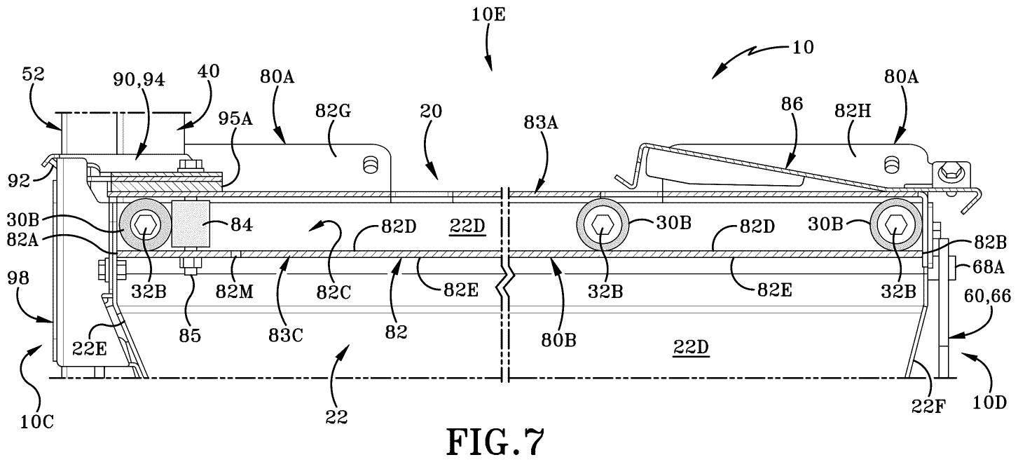

Drop spreader 20 also includes a first set of bearings 30A and a second set of bearings 30B that rotatably engage with the hopper 22. As best seen in FIG. 6, each bearing of the first set of bearings 30A rotatably engages with the front wall 22C of the hopper 22 by a first set of pivot pins 32A. The first set of bearings 30A is also positioned at the top end 22A of the hopper 22 and is external to the chamber 22G. As best seen in FIG. 7, each bearing of the second set of bearings 30B also rotatably engages with the rear wall 22D of the hopper 22 by a second set of pivot pins 32B. The second set of bearings 30B is also positioned at the top end 22A of the hopper 22 and is external to the chamber 22G. As discussed in greater detail below, the first set of bearings 30A and the second set of bearings 30B engage with a rail system to slideably move the drop spreader 20 from underneath the frame 2 of the vehicle 1 between the filling position and the dispensing position.

It should be understood that the first set of bearings 30A and the second set of bearings 30B may include any suitable number of bearings to slideably moving the drop spreader 20 from underneath the frame 2 of the vehicle 1 between the filling position and the dispensing position. Such number of bearings that may be included in the first set of bearings 30A and the second set of bearings 30B may be dictated by various considerations, including the size of the drop spreader, the overall weight of the drop spreader, and other various considerations of the like. Examples of suitable numbers of bearings to be provided in sets of bearings discussed herein include, one, two, a plurality, three, four, five, and any suitable number of bearings to slideably moving a drop spreader from underneath a frame of a vehicle between a filling position and a dispensing position. In the present disclosure, the first set of bearings 30A and the second set of bearings 30B have three bearings for slideably moving the drop spreader 20 from underneath the frame 2 of the vehicle 1 between the filling position and the dispensing position.

Drop spreader 20 also includes an upright housing 40 that operably engages with the hopper 22. As best seen in FIG. 3B, the upright housing 40 includes a top end 40A that is spaced apart from the hopper 22, and a bottom end 40B that operably engages with the hopper 22 and is opposite to the top end 40A. The upright housing 40 also includes a chamber 40C that extends between the top end 40A and the bottom end 40B to store drive components of the drop spreader 20, which are discussed in greater detail below. Upright housing 40 also includes a handle 40D that extends upwardly from the top end 40A. In operation, the handle 40D enables a user or operator of implement 10 to slideably move the drop spreader 20 from underneath the frame 2 of the vehicle 1 along a rail system of the implement 10 between the filling position and the dispensing position.

Drop spreader 20 also includes a motor 42 that operably engaged with the upright housing 40 and is housed inside a motor shield 43. In the present disclosure, the motor 42 may be mechanically connected to a drive system (not illustrated herein) that diverts rotational movement generated by the motor 42 to a primary drive shaft 46 that is located below the motor 42. Drop spreader 20 also includes a motor sprocket 48 that operably engages with the primary drive shaft 46 and engages with a drive chain 50. Upon assembly, the drive chain 50 operably engages with the rotor sprocket 24E and the motor sprocket 48 so that the rotational energy generated by the motor 42 is transferred to the rotor 24 to rotate the rotor 24 at a predetermined rate that is selected by the operator. Drop spreader 20 may also include a first shroud 52 that operably engages with the hopper 22 and the upright housing 40 to protect and shield the rotor sprocket 24E, the motor sprocket 48, and the drive chain 50 from external elements surrounding the implement 10. Drop spreader 20 may also include a second shroud 54 that operably engages with the hopper 22 to protect and shield the rotor gear 24F and the roller gear 26F from external elements surrounding the implement 10.

It should be understood that any suitable motor may be used in implement 10 to generate rotational energy and transfer said rotational energy to the rotor 24 for dispensing material from the hopper 22. In one exemplary embodiment, an electric motor may be used in implement 10 to generate rotational energy and transfer said rotational energy to the rotor 24 for dispensing material from the hopper 22. It should also be understood that while a chain drive system (i.e., rotor sprocket 24E, motor sprocket 48, and drive chain 50) is used to transfer rotational energy from the motor 42 to the rotor 24, any suitable drive transmissions and/or systems may be used to transfer rotational energy from the motor 42 to the rotor 24. Examples of suitable drive transmissions and/or systems that may be used to transfer rotational energy from a motor to a rotor of an implement described herein include a belt drive system, a gear drive system, shaft coupling systems, screw drive systems, and other suitable drive transmissions and/or systems that may be used to transfer rotational energy from a motor to a rotor of an implement discussed herein.

Drop spreader 20 also includes an agitation or anti-bridging assembly generally referred to at 60. In operation, the anti-bridging assembly 60 prevents bridging and/or accumulation of large pieces of material inside of the hopper 22 during operation. As such, the anti-bridging assembly 60 breaks up and/or dissociates large pieces of material into smaller pieces or granules of material to prevent unwanted wear on the rotor 24 and compression roller 26, down time to fill up the hopper 22 with more material, and waste of material. Such components and parts of the anti-bridging assembly 60 are discussed in greater detail below.

The anti-bridging assembly 60 includes a control arm 62 that operably engages with the rotor 24. As best seen in FIG. 5, the control arm 62 includes a first or oscillating end 62A that operably engages with the drive shaft 24C of the rotor 24 at the second end 24B by a fastener 63. The control arm 62 also includes a second end 62B that is opposite to the first end 62A and is spaced apart from the rotor 24. In operation, the first end 62A of the control arm 62 is offset from the drive shaft 24C of the rotor 24 so that the control arm 62 may oscillate at the first end 62A. Such oscillation that occurs at the first end 62A is then transferred to the second end 62B to enable oscillation along a length of the control arm 62 and to other components engaged with the control arm 62, which are discussed in greater detail below.

The anti-bridging assembly 60 also includes an articulating plate 64 that operably engages with the control arm 62. As best seen in FIG. 5, the articulating plate 64 includes a first end 64A that is spaced apart from the control arm 62 and positioned at the first side wall 22E of hopper 22, a second end 64B that operably engages with the control arm 62 and is opposite to the first end 62A, and a plurality of cutting edges 62C defined between the first end 62A and the second end 62B. In the present disclosure, the second end 64B of the articulating plate 64 engages with the second end 62B of the control arm 62 via a securement mechanism of a pair of securement mechanisms 65 (e.g., a bolt threadably engaged with a nut) in which the second end 64B of the articulating plate 64 articulates with the control arm 62.

The anti-bridging assembly 60 includes a pair of support arms 66 that operably engages with the control arm 62 and the articulating plate 64. As best seen in FIGS. 4 and 5, each support arm of the pair of support arms 66 includes a first end 66A that operably engages with the articulating plate 64 via the pair of securement mechanisms 65. In the present disclosure, a first support arm of the pair of support arms 66 operably engages with the articulating plate 64 at the first end 64A by a first securement mechanism of the pair of securement mechanisms 65, and a second support arm of the pair of support arms 66 operably engages with the articulating plate 64 at the second end 64B by a second securement mechanism of the pair of securement mechanisms 65. Additionally, the second support arm of the pair of support arms 66 also operably engages with the control arm 62 by the second securement mechanism of the pair of securement mechanisms 65. More particularly, the first end 66A of the second support arm of the pair of support arms 66 operably engages with the articulating plate 64 at the second end 64B.

Still referring to the pair of support arms 66, each support arm 66 also includes a second end 66B that is opposite to the first end 66A and is spaced apart from the articulating plate 64 (see FIGS. 4 and 5). As described in greater detail below, the second ends 66B of the pair of support arms 66 pivotably engage with a cross bar of the drop spreader 20 that is substantially positioned inside of the hopper 22.

Anti-bridging assembly 60 also includes a cross bar 68 that operably engages with the hopper 22 and the pair of support arm 66. As best seen in FIGS. 3A-3B, the cross bar 68 includes a first end 68A that operably engages with the first side wall 22E of the hopper 22 and with the first support arm of the pair of support arms 66. Cross bar 68 also includes a second end 68B that is opposite to the first end 68A and operably engages with the second side wall 22F of the hopper 22 and with the second support arm of the pair of support arms 66. Cross bar 68 may also include a longitudinal axis 68C (see FIG. 4) that extends between the first end 68A and the second end 68B. In operation, the pair of support arm 66 may rotate simultaneously about longitudinal axis 68C at the first end 68A of the cross bar 68 and at the second end 68B of the cross bar 68; such rotation is caused by the control arm 62 transferring rotational energy to the pair of support arms 66. It should also be understood that, if desired, the pair of support arms 66 and the cross bar 68 may be fixed to one another such that the pair of support arms 66 and the cross bar rotate together based on the oscillation applied by the control arm 62.

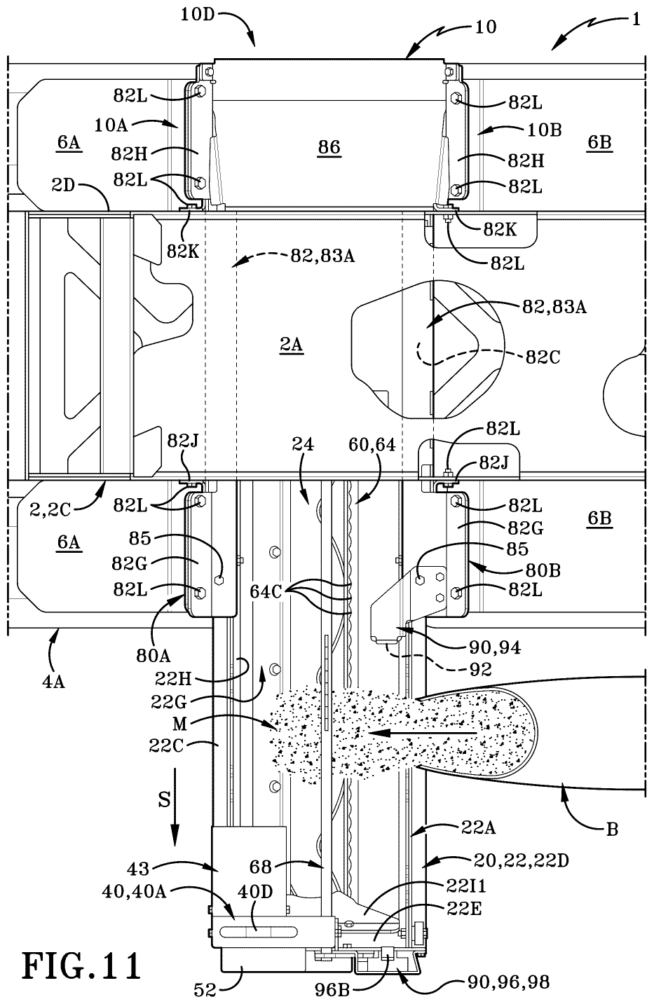

Still referring to cross bar 68, the cross bar 68 may also include a cutting member or bag breaker member 68D. As best seen in FIG. 3A, the cutting member 68D is positioned at a location between the first end 68A and the second end 68B. The cutting member 68D also extends along an axis that is nonparallel with the longitudinal axis 68C of the cross bar 68. In one exemplary embodiment, the cutting member 68D extends outwardly from the cross bar 68 along an axis that is orthogonal to the longitudinal axis 68C of the cross bar 68. In operation, the cutting member 68D is configured to rip or break through a material bag (labeled “B” in FIG. 11) that holds the desired material (labeled “M” in FIGS. 1 and 11) while the bag is positioned over the hopper 22. In the present disclosure, the cutting member 68D includes at least one cutting tooth and/or spike that may penetrate and break the bag for ease of filling and loading the material into the hopper 22.

Still referring to cross bar 68, the cross bar 68 may also include a director or directing plate 68E. As best seen in FIG. 3A, the directing plate 68E is positioned at a location between the first end 68A and the second end 68B below the cutting member 68D. The directing plate 68E also extends outwardly from the cross bar 68 along an axis that is nonparallel with the longitudinal axis 68C of the cross bar 68. In one exemplary embodiment, the directing plate 68E extends along an axis that is orthogonal to the longitudinal axis 68C of the cross bar 68. In operation, the directing plate 68E is configured to direct and/or guide the material from the top end 22A of the hopper 22 towards the bottom end 22B to be dispensed by the rotor 24 and the compression roller 26. In the present disclosure, the directing plate 68E defines a plurality of openings and/or apertures that may allow material to pass through the directing plate 68E as the material is directed by the directing plate 68E and moves downwardly towards the rotor 24 and the compression roller 26.

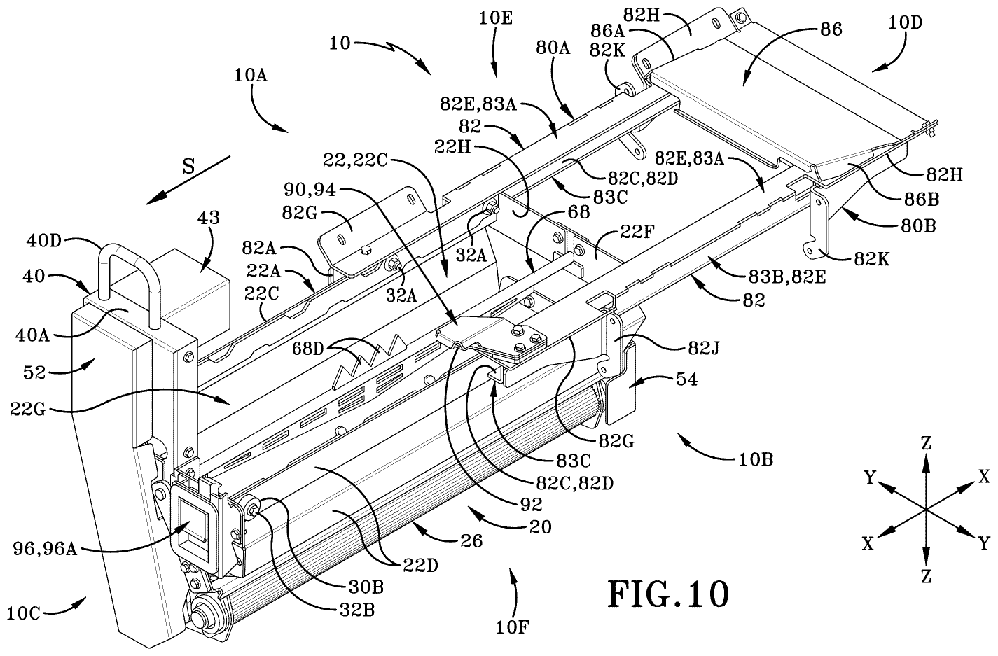

Implement 10 also includes a rail system 80A, 80B that operably engages with the vehicle 1 and the drop spreader 20. As best seen in FIGS. 1, 9, and 11, the rail system 80A, 80B fixedly engages with the vehicle 1 at the frame 2 (via the front pair of attachment openings 2F and the rear pair of attachment openings 2G), at the front fenders 6A, and at the rear fenders 6B and is position between the front wheels 4A and the rear wheels 4B. As best seen in FIGS. 10-12, the rail system 80A, 80B also enables the drop spreader 20 to slideably move along the rail system 80A, 80B between the filling position (when loading material into the hopper 22) and the dispensing position (when dropping material from the hopper 22 and onto a ground path or surface). Such features and components of the rail system 80A, 80B are discussed in greater detail below.

In the present disclosure, the rail system 80A, 80B includes a first rail system 80A and a second rail system 80B that operably engage with the frame 2 (via the front pair of attachment openings 2F and the rear pair of attachment openings 2G), the front fenders 6A, and the rear fenders 6B where first rail system 80A and second rail system 80B face one another relative the transverse axis “X” of the vehicle 1. It should be understood that first rail system 80A and second rail system 80B are identical to one another; for brevity, the following description will pertain to the second rail system 80B that operably engages with the frame 2 (via the rear pair of attachment openings 2G) and the rear fenders 6B. It should also be understood that while the second rail system 80B operably engages with the frame 2 at the rear pair of attachment openings 2G and with the rear fenders 6B as described herein, the description of the second rail system 80B applies equally to first rail system 80A that operably engages with the frame 2 (via the front pair of attachment openings 2F) and the front fenders 6A.

With respect to the second rail system 80B, the second rail system 80B includes a roller rail 82. As best seen in FIG. 7, the roller rail 82 includes a first end 82A that is positioned at the first side wall 22E of the hopper 22, a second end 82B opposite to the first end 82A and is positioned at the second side wall 22F of the hopper 22, and a longitudinal direction defined therebetween. Roller rail 82 also defines a track or channel 82C that extends between the first end 82A and the second end 82B along an interior surface 82D of the roller rail 82; such use and purpose of the track 82C and the interior surface 82D is discussed in greater detail below. Roller rail 82 also includes an exterior surface 82E that is positioned external to the track 82C and extends between the first end 82A and the second end 82B opposite to the interior surface 82D; such use and purpose of exterior surface 82E is also discussed in greater detail below

Still referring to roller rail 82, roller rail 82 also includes a stop plate 82F. As best seen in FIG. 7, the stop plate 82F is positioned at the second end 82B and extends over the track 82C such that the stop plate 82F prevents accessibility into the track 82C at the second end 82B. Such inclusion of the stop plate 82F prevents the drop spreader 20 from exiting the track 82C of the roller rail 82 at the second end 82B such that the stop plate 82F directly abuts a bearing of the second set of bearings 30B.

Still referring to roller rail 82, roller rail 82 also includes a pair of mounting brackets 82G, 82H and a pair of side flanges 82J, 82K. As best seen in FIG. 3B, the pair of mounting brackets 82G, 82H are spaced apart from one another along the longitudinal direction of the roller rail 82. In one exemplary embodiment, a first mounting bracket 82G is provided at the first end 82A of the roller rail 82 and extends outwardly from the exterior surface 82E. In this same exemplary embodiment, a second mounting bracket 82H is provided at the second end 82B of the roller rail 82 and extends outwardly from the exterior surface 82E; the second mounting bracket 82H is longitudinally opposite to the first mounting bracket 82G. In the present disclosure, the pair of mounting brackets 82G, 82H operably engages with the frame 2, particularly the rear fenders 6B of the vehicle 1, by a set of attachment mechanisms 82L (see FIGS. 1 and 9-11). The pair of mounting brackets 82G, 82H is bent upwardly at an angle from the exterior surface 82E wherein the angle of the pair of mounting brackets 82G, 82H matches with angles of the rear fenders 6B.

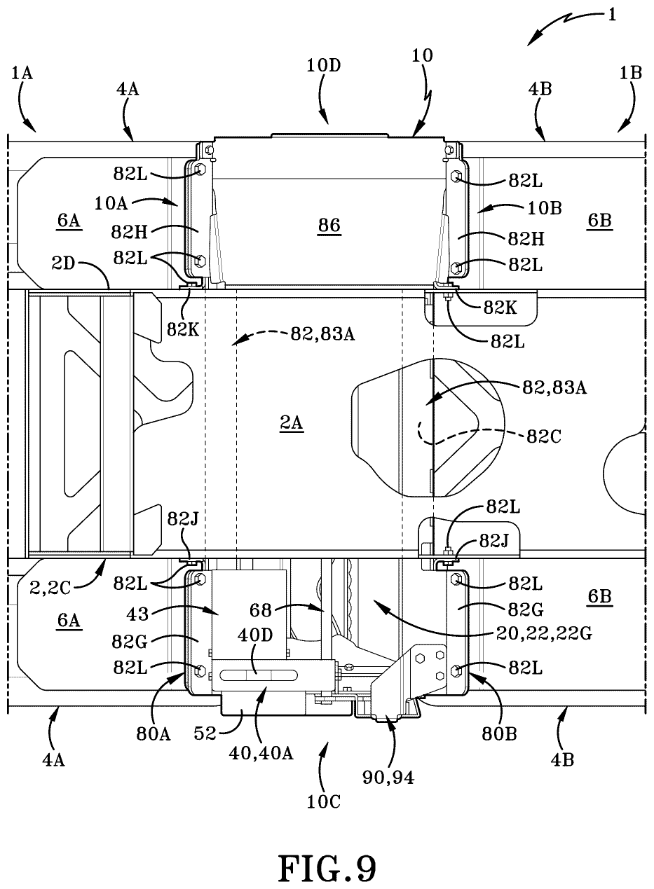

With respect to the pair of side flanges 82J, 82K, the pair of side flanges 82J, 82K are also spaced apart from one another along the longitudinal direction of the roller rail 82 when viewed from a top plan view (see FIG. 9). In one exemplary embodiment, a first side flange 82J is provided proximate to the first end 82A of the roller rail 82 and extends outwardly from the exterior surface 82E. In this same exemplary embodiment, a second side flange 82K is provided proximate to the second end 82B of the roller rail 82 and extends outwardly from the exterior surface 82E; the second side flange 82K is longitudinally opposite to and faces the first side flange 82J. In the present disclosure, the pair of side flanges 82J, 82K operably engages with the frame 2, particularly the sides 2C, 2D of the frame 2 of the vehicle 1 at the rear pair of attachments openings 2G, by the set of attachment mechanisms 82L. The pair of side flanges 82J, 82K is also bent outwardly from one another at an angle from the exterior surface 82E wherein the angle of the pair of side flanges 82J, 82K matches with an angle of the sides 2C, 2D of the frame 2.

The roller rail 82 also defines at least one notch 82M. As best seen in FIGS. 7 and 12, the notch 82M is defined in the roller rail 82 at a location between the first end 82A and the second end 82B that closer to the first end 82A. In present disclosure, the notch 82M is also defined inside of the track 82C such that the notch 82M is defined in the interior surface 82D. In one exemplary embodiment, the notch 82M extends downwardly into at least the interior surface 82D inside of the track 82C such that the interior surface 82D is non-continuous and/or interrupted. In another exemplary embodiment, the notch 82M extends entirely through the roller rail 82 such that the track 82C and the exterior environment surrounding the roller rail 82 are in operable communication with one another at the notch 82M. In operation, the notch 82M traps and/or captures a portion of one of the bearings of the set of bearings 30B as the drop spreader 20 moves from the dispensing position to the filling position; such interaction between the bearing of the set of bearings 30B and the roller rail 82 inside of the notch 82M prevents the drop spreader 20 from accidentally moving back to the dispensing position when the vehicle 1 and implement 10 are located on a sloped surface causing the drop spreader 20 to move.

The roller rail 82 also includes a set of engagement walls 83A, 83B, 83C. As best seen in FIG. 6A, a first engagement wall 83A extends longitudinally between the first end 82A and the second end 82B, a second engagement wall 83B that extends longitudinally between the first end 82A and the second end 82B and operably engage with the first engagement wall 83A, and a third engagement wall 83B that extends longitudinally between the first end 82A and the second end 82B and operably engage with the second engagement wall 83B. In the present disclosure, the second engagement wall 83B is positioned between the first engagement wall 83A and the second engagement wall 83C while the first engagement wall 83A and the third engagement wall 83C are spaced apart from one another and parallel with one another. As best seen in FIG. 6A, the set of bearings 30B of the drop spreader 30 engage with at least the third engagement wall 83C inside of the track 82C so that the drop spreader 20 is slidably moveable along the roller rail 82.

It should be understood that the set of engagement walls 83A, 83B, 83C may collectively define the interior surface 82D and the exterior surface 82E of the roller rail 82. It should also be understood that the set of engagement walls 83A, 83B, 83C may be engaged and/or attached with one another in any suitable configuration to allow the set of bearings 30B to engage with at least the first engagement wall 83A inside of the track 82C so that the drop spreader 20 is slidably moveable along the roller rail 82. In one exemplary embodiment, the second engagement wall 83B and the third engagement wall 83C define a single piece or component of roller rail 82 in which the second engagement wall 83B and the third engagement wall 83C are integral with one another. In another exemplary embodiment, the first engagement wall 83A is a separate piece or component from the second engagement wall 83B and the third engagement wall 83C.

The second rail system 80B also includes stop bushing 84. As best seen in FIGS. 7 and 12, the stop bushing 84 is positioned inside of the track 82C at the first end 82A of the roller rail 82. Particularly, stop bushing 84 is fixedly engaged with the roller rail 82 inside of the track 82C by a fastener mechanism 85 (e.g., a fastener threadably engaged with a nut) between the first end 82A and the notch 82M defined in the roller rail 82. More specifically, stop bushing 84 is fixedly engaged with the first engagement wall 83A and the third engagement wall 83C of the roller rail 82 inside of the track 82C by fastener mechanism 85 between the first end 82A and the notch 82M. Such inclusion of the stop bushing 84 prevents the drop spreader 20 from being completely removed and disengaged from the second rail system 80B as the drop spreader 20 is moved from the dispensing position to the filling position. Particularly, the stop bushing 84 directly abuts and blocks one of the bearings of the set of bearings 30B from any further linear movement along the roller rail 82. As such, the stop bushing 84 is the final position at which the drop spreader 20 may move relative to the roller rail 82.

The rail systems 80A, 80B may also include a guard 86. In the present disclosure, the guard 86 operably engages with the roller rails 82 of the first rail system 80A and the second rail system 80B. Particularly, and as best seen in FIG. 10, the guard 86 includes a first end 86A that operably engages with the roller rail 82 of the first rail system 80A, and a second end 86B that operably engages with the roller rail 82 of the second rail system 80B opposite to the first end 86A. In operation, the guard 86 covers a portion of the fill opening 22H of the hopper 22 near the second side wall 22F of the hopper 22 to prevent unwanted material from entering into the chamber 22G of the hopper 22 during operation.

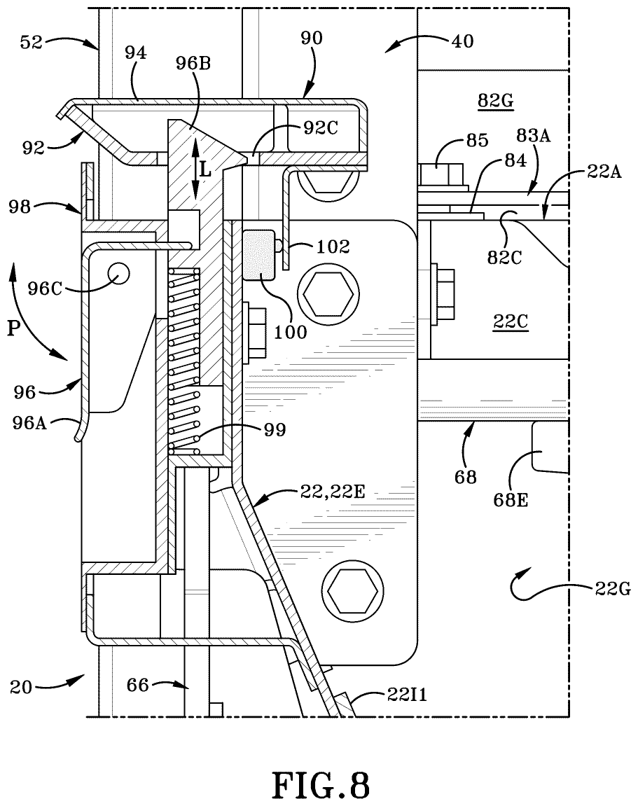

Implement 10 also includes a latch system 90 that operably engages with the drop spreader 20 and the rail systems 80A, 80B. In the present disclosure, the latch system 90 may be provided in a locked configuration where the latch system 90 locks the drop spreader 20 in the dispensing position and prevents movement of the drop spreader 20 along the rail systems 80A, 80B (see FIG. 8). The latch system 90 may also be provided in an unlocked configuration where the latch system 90 allows the drop spreader 20 to move along the rail systems 80A, 80B from the dispensing position the filling position (see FIGS. 10-11). Such parts of the latch system 90 are discussed in greater detail below.

Latch system 90 includes a strike plate 92 that operably engages with the first rail system 80A or the second rail system 80B. As best seen in FIG. 4, the strike plate 92 includes a first end 92A, a second end 92B that operably engages with the roller rail 82 of the first rail system 80A, and a lock aperture 92C defined proximate to the first end 92A (see FIG. 8). In the present disclosure, the first end 92A and the lock aperture 92C of the strike plate 92 are spaced apart and remote from the roller rail 82 of the first rail system 80A such that the first end 92A and the lock aperture 92C are disposed above the top end 22A and the fill opening 22H of the hopper 22. Latch system 90 may also include a cover plate 94 that operably engages with the strike plate 92. As best seen in FIG. 8, the cover plate 94 is positioned above the strike plate 92 and substantially covers the lock aperture 92C to protect the lock aperture 92C from the external elements surrounding the implement 10.

It should be understood that additional and/or optional components may be included in the latch system 90. In one instance, one or more shims 95A may be placed below the strike plate 92 and the cover plate 94 to elevate the vertical position of the strike plate 92 and the cover plate 94. Such use of shim 95A may be advantageous so that the strike plate 92 is set at a suitable vertical position in which a latch of the latch system 90 may engage with the strike plate 92 to prevent linear movement of the drop spreader 20 along the rail systems 80A, 80B; such latch of the latch system 90 is discussed in greater detail below. In the same or another instance, one or more attachment mechanisms 95B (i.e., bolts that threadably engage with the nuts) may be used to operably engage the strike plate 92, the cover plate 94, and shim 95A with the first rail system 80A.

Latch system 90 also includes a latch mechanism 96 that operably engages with the drop spreader 20 inside a housing 98. As best seen in FIG. 8, the latch mechanism 96 includes a lever or latch 96A that is housed inside of the housing 98. The latch mechanism 96 also includes a locking pin 96B that extends upwardly from the lever 96A. The latch mechanism 96 may also include a pivot pin 96C that pivotably engages with the lever 96A with the housing 98 so that the lever 96A pivots and moves the locking pin 96B between a locked position and an unlocked position; such pivoting of the lever 96A is denoted by a double arrow labeled “P” in FIG. 8, and such movement of the locking pin 96B is denoted by a double arrow labeled “L” in FIG. 8. In the locked position, the locking pin 96B is housed inside of the lock aperture 92C and operably engages with the strike plate 92 inside the lock aperture 92C to prevent movement of the drop spreader (see FIG. 9). In the unlocked position, the locking pin 96B is remote from the lock aperture 92C and disengages from the strike plate 92 to allow movement of the drop spreader when operator lifts and/or actuates the lever 96A from the housing 98; such actuation of the lever 96A simultaneously retracts the locking pin 96B from the lock aperture 92C and disengages the locking pin 96B from the strike plate 92.

Latch system 90 may also include a biaser 99. As best seen in FIG. 8, biaser 99 operably engages with the latch mechanism 96 inside of the housing 98 to continuously bias the latch mechanism 96 to the locked position. Particularly, biaser 99 operably engages with the locking pin 96B of the latch mechanism 96 inside of the housing 98 to continuously bias the locking pin 96B to the locked position. It should be understood the biasing force applied by the biaser 99 is overcome when the operator applies a pressure to the lever 96A that is greater than the biasing force applied by the biaser 99 to move the locking pin 96B from the lock aperture 92C of the strike plate 92.

Implement 10 may also include a latch sensor 100. In the present disclosure, the latch sensor 100 is operably engages with the first rail system 80A or the second rail system 80B and is in operable communication with the motor 42 by a wired connection or a wireless connection. As best seen in FIG. 8, the latch sensor 100 is operably engaged with the second rail system 80B and may be actuated between a first or activated state and a second or deactivated state by the hopper 22. In the activated state, the hopper 22 depresses the latch sensor 100 when the hopper 22 is provided in the dispensing position (see FIG. 8); in this position, the latch sensor 100 may output an electrical pulse or signal to the motor 42 and/or a controller provided with the vehicle 1 so that motor 42 may operate and generate rotational energy. In the deactivated state, the hopper 22 is free from pressing the latch sensor 100 when the hopper 22 is provided in the filling position; in this position, the latch sensor 100 is free from outputting an electrical pulse or signal to the motor 42 and/or a controller provided with the vehicle 1 so that motor 42 refrains from operating and generating rotational energy. Such inclusion of the latch sensor 100 prevents the motor 42 from accidentally and/or incidentally operating and dispensing material from the hopper 22 when an operator of the implement 10 filling the hopper 22.

It should be understood that implement 10 may also include a control system for controlling the dispensing rate of material from the hopper 22. Such control system may include a controller that is accessible to the operator when stationed on the operator platform 7. Such controller may be in operative communication with the motor 42 by a control wiring harness. The control system may also include a power wiring harness that connects the motor 42 and an on-board power supply (e.g., battery powering the vehicle 1) with one another so the motor 42 may operate and generate rotational energy for a desired amount of time. In operation, the controller may be operated by the operator of the vehicle 1 and implement 10 in which the controller may provide a plurality of features in controlling the motor 42. In one instance, the controller may enable the operator to initiate operation of the motor 42 so that the motor 42 generates rotational energy to dispense the material from the hopper 22 based on the mechanical configuration between the rotor 24, the compression roller 26, the motor 42, and the anti-bridging assembly 60. In another instance, the controller may enable the operator to set a desired rate of dispensing material by controlling the speed at which the motor 42 generates rotational energy.

It should be understood that while it is desirable for the motor 42 and a controller to be in operable communication with one another via wired connection (i.e., a control wiring harness), any suitable electrical connection may be used to operably connect the motor 42 and the controller with one another. In one instance, a wireless electrical connection may be used to electrically connect the motor 42 and a controller with one another; any commercially-available wireless system or wireless system that is currently not available may be used.

Having now described the components of the implement 10, methods of filling the implement 10 and dispensing material from the implement 10 are discussed in greater detail below.

Prior to dispensing material from the drop spreader 20, the drop spreader 20 is located beneath the vehicle 1 in the dispensing position (see FIG. 9). In this position, the hopper 22 is partially covered by the frame 2 of the vehicle 1. In the dispensing position, the latch mechanism 96 is also operably engaged with the strike plate 92 such that drop spreader 20 is locked and/or held with the rail systems 80A, 80B at the dispensing position to prevent linear movement of the drop spreader 20. In the dispensing position, the latch sensor 100 is also provided in the activated state in which the motor 42 is operable to generate rotational energy when initiated by the operator.

Prior to dispensing material from the drop spreader 20, the operator of the implement 10 may slide the drop spreader 20 along the rails systems 80A, 80B from the dispensing position to the filling position to fill the hopper 22 with desired material. In the present disclosure, the operator of implement 10 unlocks the drop spreader 20 from rail systems 80A, 80B by disengaging the latch mechanism 96 from the strike plate 92. Particularly, the operator disengages the locking pin 96B of the latch mechanism 96 from the lock aperture 92C of the strike plate 92 by lifting the lever 96A of the latch mechanism 96 upwardly and away from the housing 98 until the locking pin 96B is outside of the lock aperture 92C (see FIG. 8).

Once the drop spreader 20 is provided in the unlocked position, the operator may then grasp and pull on the handle 40D of the drop spreader 20 to slide drop spreader 20 along the rail systems 80A, 80B from the dispensing position to the filling position. Particularly, the operator pulls on the handle 40D in a direction that is parallel to the second direction “X” of the implement 10 to slide the drop spreader 20 from the dispensing position to the filling position. In the present disclosure, the sets of bearings 30A, 30B may slide along the interior surface 82D of the roller rails 82 inside of the tracks 82C as the operator moves the drop spreader 20 outwardly from beneath the vehicle 1. The operator may continue to pull on the handle 40D of the drop spreader 20 until a bearing of each set of bearings 30A, 30B directly abuts and engages with a corresponding stop bushing 84 of the rail systems 80A, 80B. As discussed above, the stop bushings 84 prevent any further linear movement of the drop spreader 20 so that the drop spreader 20 is retained inside of the roller rails 82 at the filling position.

Once the respective bearings of the sets of bearings 30A, 30B and the stop bushings 84 directly abut one another, the drop spreader 20 is provided in the filling position relative to the rail systems 80A, 80B. In this filling position, the drop spreader 20 is cantilevered from the rail system 80A, 80B so that a portion of the fill opening 22H of the hopper 22 is unobstructed by the frame 2 of the vehicle 1 (see FIG. 11). In this filling position, the drop spreader 20 is also positioned wider than and/or outside of the front wheels 4A and the rear wheels 4B where a portion of the drop spreader 20 is offset from the front wheels 4A and the rear wheels 4B (see FIG. 11). In the filling position, at least one bearing in each set of bearings 30A, 30B is also trapped and/or captured by the notch 82M defined in each roller rails 82 to prevent the drop spreader 20 from sliding back to the dispensing position (see FIG. 12); such capturing by the notch 82M may be considered advantageous when the vehicle 1 and the implement 10 are positioned on a slight grade that would cause the implement 10 to slide back to the dispensing position. In the filling position, the latch sensor 100 is also provided in the deactivated state to prevent the motor 42 from being activated to an operating state that generates rotational energy.

Once a desired amount of material is provided in the hopper 22, the operator may then grasp and push on the handle 40D of the drop spreader 20 to slide drop spreader 20 along the rail systems 80A, 80B from the filling position back to the dispensing position. Particularly, the operator pushes on the handle 40D in a direction that is parallel to the second direction “X” of the implement 10 to slide the drop spreader 20 from the filling position to the dispensing position. In the present disclosure, the sets of bearings 30A, 30B may slide along the interior surface 82D of the roller rails 82 inside of the tracks 82C as the operator moves the drop spreader 20 into the vehicle 1. The operator may continue to push on the handle 40D of the drop spreader 20 until a bearing of each set of bearings 30A, 30B directly abuts and engages with the corresponding stop plate 82F of the rail systems 80A, 80B. As discussed above, the stop plate 82F prevent any further linear movement of the drop spreader 20 so that the drop spreader 20 is retained inside of the roller rails 82 at the dispensing position.

In this dispensing position, the drop spreader 20 is also positioned even with and/or inside of the front wheels 4A and the rear wheels 4B where the drop spreader 20 defines a substantially similar width as compared to distance between the front wheels 4A and the rear wheels 4B (see FIG. 9). In the dispensing position, the latch sensor 100 is also provided in the activated state to provide the motor 42 in the operating state to generate rotational energy for dispensing material from the hopper 22.

Once provided in the dispensing position, the operator may then initiate operation of the motor 42, via a controller, so that the drop spreader 20 may dispense a desired amount of material at a desired rate. Once the motor 42 generates rotational energy, the motor 42 applies rotation to the drive system 44 which is then transferred to the primary drive shaft 46 and motor sprocket 48. As the motor sprocket 48 rotates, the drive chain 50 rotates with the motor sprocket 48 which in turn rotates the rotor sprocket 24E of rotor 24. Such rotation of the rotor sprocket 24E occurs due to the drive chain 50 connecting with the motor sprocket 48 and the rotor sprocket 24E which enables the motor 42 to transfer rotational energy to the rotor 24.

As the rotor sprocket 24E receives rotational energy from the drive chain 50, the rotational energy is then transferred to the drive shaft 24C so that the rotor 24 begins to rotate in a first rotational direction about the longitudinal axis defined by the rotor 24. As the rotor 24 rotates in the first rotational direction, the rotational energy is then transferred to the compression roller 26 due to the meshing between the rotor gear 24F and the roller gear 26F. Once the roller gear 26F receives rotational energy from the rotor gear 24F, the rotational energy is then transferred to the drive shaft 26C so that the compression roller 26 begins to rotate in a second rotational direction about the longitudinal axis defined by the compression roller 26. Based on the gearing between the rotor gear 24F and the roller gear 26F, second rotational direction of the compression roller 26 is opposite to the first rotational direction of the rotor 24 such that the rotor 24 and the compression roller 26 are rotating towards one another. With such rotation, the rotor 24 and the compression roller 26 may dispense material at a predetermined rate onto the ground surface or path. It should be noted that the rotational speed of the rotor 24 and the compression roller 26 is dictated based on the speed of the motor 42.

Concurrently, the rotational energy of the rotor 24 is also transferred to the anti-bridging assembly 60. Particularly, the rotor 24 transfers the rotational energy to the control arm 62 due to the engagement between the rotor 24 and the first end 62A of the control arm 62 (see FIG. 5). Once the control arm 62 receives the rotational energy from the rotor 24, the control arm 62 oscillates at the speed of the rotor 24 based on the structural configuration between the first end 62A of the control arm 62 and the drive shaft 24C of the rotor 24. Specifically, the first end 62A of the control arm 62 oscillates about the drive shaft 24C of the rotor 24 as the drive shaft 24C rotates in the first rotational direction.

As the control arm 62 begins to oscillate, the control arm 62 then transfers this oscillation energy to the articulating plate 64, particularly at the second end 64B of the articulating plate 64 (see FIG. 5). Once the oscillation energy is received at the second end 64B, the articulating plate 64 begins to moves along the rear wall 22D of the hopper 22 in a front-to-rear linear direction. In operation, the articulating plate 64 is configured to cut and break bridged material into small pieces and/or granules prior to said material be dispensed by the rotor 24 and the compression roller 26. The oscillation energy is also transferred along the entire length of the articulating plate 64 to the first end 64A so that the entire articulating plate 64 moves in the front-to-rear linear direction. The anti-bridging assembly 60 continues to oscillate and break up material inside of the hopper 22 as long as the rotor 24 rotates in the first rotational direction.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

While components of the present disclosure are described herein in relation to each other, it is possible for one of the components disclosed herein to include inventive subject matter, if claimed alone or used alone. In keeping with the above example, if the disclosed embodiments teach the features of A and B, then there may be inventive subject matter in the combination of A and B, A alone, or B alone, unless otherwise stated herein.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/31 0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

To the extent that the present disclosure has utilized the term “invention” in various titles or sections of this specification, this term was included as required by the formatting requirements of word document submissions pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed is:

1. An implement for attachment with a vehicle, the implement comprising:
at least one rail system operably engaged with the vehicle; and
a drop spreader moveably engaged with the at least one rail system between a filling position and an operating position;
wherein the drop spreader is cantilevered from the vehicle by the at least one rail system.

2. The implement of claim 1, wherein the at least one rail system comprises:
a first end;
a second end opposite to the first end; and
a longitudinal direction defined between the first end and the second end;
wherein the drop spreader is moveable along the longitudinal direction between the filling position and the operating position;
wherein the longitudinal direction of the at least one rail system is nonparallel with a longitudinal direction of the vehicle.

3. The implement of claim 1, wherein the at least one rail system further comprises:
a roller rail operably engaged with the vehicle; and
wherein the drop spreader comprises:
a hopper configured to hold material; and
at least one set of bearings rotatably engaged with the hopper and with the roller rail to move the hopper between the filling position and the operating position.

4. The implement of claim 3, wherein the hopper further comprises:
a front wall;
a rear wall opposite to the front wall;
a pair of side walls operably engaged with the front wall and the rear wall and spaced apart from one another; and
a chamber collectively defined by the front wall, the rear wall, and the pair of side walls that holds the material;
wherein the set of bearings operably engages with at least one of the front wall and the rear wall external to the chamber.

5. The implement of claim 3, wherein the at least one rail system further comprises:
a stop bushing operably engaged with the roller rail;
wherein when the drop spreader is in the operating position, the stop bushing contacts a first bearing of the at least one set of bearings.

6. The implement of claim 5, wherein the roller rail of the at least one rail system further comprises:
a first end;
a second end opposite to the first end; and
a notch defined in the roller rail between the stop bushing and the second end;
wherein when the drop spreader is in the operating position, the roller rail captures the first bearing of the at least one set of bearings inside of the notch.

7. The implement of claim 6, wherein the roller rail of the at least one rail system further comprises:
a stop plate positioned at the second end of the roller rail and being spaced apart from the stop bushing;
wherein when the drop spreader is in the filling position, the stop plates engages with a second bearing of the at least one set of bearings inside of the notch.

8. The implement of claim 3, wherein the roller rail of the at least one rail system further comprises:
at least one mounting bracket configured to operably engage the at least one rail system with a front fender of the vehicle or a rear render of the vehicle.

9. The implement of claim 3, wherein the roller rail of the at least one rail system further comprises:
at least one side flange configured to operably engage the at least one rail system with a frame of the vehicle.

10. The implement of claim 1, further comprising:
a latch system operably engaged with the drop spreader and the at least one rail system;
wherein the latch system is configured to maintain the drop spreader in the operating position relative to the at least one rail system.

11. The implement of claim 10, wherein the latch system comprises:
a strike plate fixedly engaged with the at least one rail system; and
a latch fixedly engaged with the drop spreader and operably engaged with the strike plate in the operating position.

12. The implement of claim 10, wherein the latch system further comprises:
a latch sensor operatively in communication with a motor of the drop spreader;
wherein when the drop spreader is provided in the operating position, the latch sensor is in an activated state to allow the motor to operate; and
wherein when the drop spreader is provided in the filling position, the latch sensor is in a deactivated state to prevent the motor from operating.

13. The implement of claim 1, further comprising:
at least another rail system operably engaged with the vehicle and positioned opposite to the at least rail system;
wherein the drop spreader is moveably engaged with the at least one rail system and the at least another rail system between the filling position and the operating position.

14. A method of spreading a material along a ground surface, comprising:
engaging an implement to a vehicle, the implement comprising:
at least one rail system operably engaged with the vehicle; and
a drop spreader moveably engaged with the at least one rail system between a filling position and an operating position, wherein the drop spreader is cantilevered from the vehicle by the at least one rail system;
moving the drop spreader along the at least one rail system in a first linear direction from the operating position to the filling position;
filling the drop spreader with the material in the filling position;
moving the drop spreader along the at least one rail system in a second linear direction from the filling position to the operating position; and
spreading the material along the ground surface.

15. The method of claim 14, wherein the steps of moving the drop spreader along the at least one rail system in the first and second linear directions further includes that the first and second linear directions are nonparallel with a longitudinal direction of the vehicle.

16. The method of claim 14, wherein the steps of moving the drop spreader along the at least one rail system in the first and second linear directions further comprises:
engaging at least one set of bearings of the drop spreader with a roller rail of the at least one rail system; and
sliding the drop spreader along the roller rail.

17. The method of claim 16, further comprising:
stopping a first bearing of the at least one set of bearings with a stop bushing of the at least one rail system; and
wherein engagement between the first bearing and the stop bushing defines the filling position.

18. The method of claim 16, further comprising:
capturing a first bearing of the at least one set of bearings inside of a notch defined by the roller rail; and
holding the drop spreader at the filling position.

19. The method of claim 17, further comprising:
stopping a second bearing of the at least one set of bearings with a stop plate of the at least one rail system; and
wherein engagement between the second bearing and the stop plate defines the operating position.

20. The method of claim 14, further comprising:
disengaging a latch of a latch assembly from a strike plate of the latch assembly; and
enabling movement of the drop spreader between the filling position and the operating position relative to the at least one rail system.

21. The method of claim 20, further comprising:
activating operation of a motor of the drop spreader, by a latch sensor of the latch assembly, when the drop spreader is in the operating position; and
deactivating operation of the motor of the drop spreader, by the latch sensor of the latch assembly, when the drop spreader is in the filling position.
